(19) United States
(12) Patent Application Publication
(10) Pub. No.: US 2004/0093226 A1
(43) Pub. Date: May 13, 2004

(54) Distributed method and system for managing volunteers and other individuals engaged in fundraising campaign

(76) Inventor: Harry E. Gruber, Rancho Santa Fe, CA (US)

Correspondence Address: Kintera, Inc., Attn: Michael Rahman, Suite 240, 9605 Scranton Road, San Diego, CA, 92121-1768, US

(21) Appl. No.: 10/290,678

(22) Filed: Nov. 8, 2002

(51) Int. Cl. G06F 17/60

(52) U.S. Cl. 705/1; 707/104.1; 705/7

(57) ABSTRACT

A system and method for efficiently managing a fundraising campaign over a wide-area network is disclosed. In accordance with one embodiment the invention, a web-based method for managing and supervising a plurality of volunteers, employees, staff, solicitors and/or other individuals engaged in solicitation on behalf of a nonprofit organization from prospects, each solicitor being assigned to solicit one or more prospects, the method utilizing one or more web pages on the Internet, comprises providing prospect data to the solicitor, providing one or more tasks assigned to the solicitor, the tasks including contacting the prospects, establishing a relationship with the prospects and soliciting donations from the prospects, and providing a status response including updates from the solicitor regarding the status of the tasks.

### BACKGROUND

1. Field of Invention

The present invention relates to a web-based distributed management system and method for supervising, managing and motivating volunteers, employees, staff, solicitors and other individuals engaged in soliciting donations and sponsorships for nonprofit, charitable or other organizations.

2. Related Art

This application is related to a prior application titled “SYSTEM AND METHOD FOR INTERACTIVE FUNDRAISING OVER A WIDE AREA NETWORK”, filed Dec. 12, 2000, Attorney Docket No. 0001.US00. The subject matter of the prior application is incorporated herein by reference in its entirety.

Charitable, nonprofit, political and other organizations (hereinafter generally referred to as nonprofit organizations) often raise money through solicitations. Nonprofit organizations establish contact with potential donors and prospects (hereinafter generally referred to as prospects) that may lead the prospects to make a charitable contribution to the organizations. Common fundraising methods include mail campaigns, gala events, participatory events such as walkathons, online solicitations and telephone calls.

Nonprofit organizations often enlist individuals such as, for example, volunteers, employees, staff (hereinafter generally referred to as “solicitors”), to solicit donations from prospects. These solicitors are not provided with efficient tools to select prospects, contact prospects or track and communicate progress. Often the solicitors are not easily provided with adequate information about the prospects. Often the solicitors are in a geographically different location from the nonprofit organization.

Other than simple non-automated email reminders, at present there is no web-based method or system that allows the nonprofit organizations to efficiently manage and supervise its solicitors over the Internet. There is no web-based method or system that allows the nonprofit organizations to closely monitor the solicitor's overall performance or his interactions with the prospects. There is no method or system that allows the nonprofit organizations to efficiently allocate solicitor resources. There is no web-based method or system that allows the nonprofit organization to efficiently provide prospect information that will allow more efficient prospect allocation or targeted solicitations that leads to significant donations. There is no web-based method or system that allows efficient sharing of prospect data and campaign progress with solicitors.

Accordingly, there is a need for a web-based method and system that increases the efficiency of a fundraising campaign. There is a need for a method and system that allows the nonprofit organization to efficiently manage and supervise solicitors over the Internet. There is a further need for a method and system that allow the nonprofit organizations to closely monitor the solicitor's overall performance and his interactions with the prospects. There is a further need for a method and system that allow the nonprofit organizations to efficiently allocate solicitor resources. There is a further need for a method and system that allows efficient sharing of prospect data and campaign progress with solicitors.

### SUMMARY OF THE INVENTION

It is an object of the present invention to provide a system and method for efficiently conducting a fundraising campaign over a wide-area network. It is a further object of the invention to provide a web-based method and system to efficiently manage and supervise volunteers, employees, staff and/or other individuals (hereinafter generally referred to as “solicitors”) in a fundraising campaign. In one embodiment of the invention, a web-based method for managing and supervising a plurality of solicitors engaged in solicitation on behalf of an organization from prospects, each solicitor being assigned to solicit one or more prospects, the method utilizing one or more web pages on the Internet, comprises providing prospect data to the solicitor, providing one or more tasks assigned to the solicitor, the tasks including contacting the prospects, establishing a relationship with the prospects and soliciting donations from the prospects, and providing a status response including updates from the solicitor regarding the status of the tasks.

The method further comprises the step of adding new tasks. The method further comprises the step of receiving a donation from the prospect. The method further comprises the step of determining the total amount of money raised by each solicitor. The method further comprises the step of ranking the volunteers based on the amount of money raised.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like elements, in which:

FIG. 1 illustrates a scenario in which the invention is utilized to supervise volunteers;

FIG. 2 is a flow diagram of the method steps in accordance with one embodiment of the invention; and

FIG. 3 is flow diagram of additional method steps of the invention.

### DETAILED DESCRIPTION OF THE INVENTION

The invention allows a nonprofit organization to efficiently manage and supervise volunteers, employees, staff and/or other individuals (hereinafter generally referred to as “solicitors”) engaged in a fundraising campaign. The invention allows the nonprofit organization to closely monitor the solicitor's overall performance and her interactions with the prospects.

The invention allows the nonprofit organization to efficiently share prospect information or data and campaign data with solicitors. The solicitors use the prospect data to solicit more effectively. The invention provides solicitors with a list of prospects and other relevant prospect data such as, for example, prospect's donation history, financial situation, age, education, employment, prior relationships and social groups and interests. The information allows the solicitors to more effectively target prospects and increase the likelihood of significant donations.

The invention allows the nonprofit organization to efficiently allocate solicitor resource. The invention allows the nonprofit organization to determine whether a solicitor's performance is satisfactory or unsatisfactory. Based on the solicitor's performance, the nonprofit organization can decide how to utilize the solicitor. For example, if the solicitor's performance is highly satisfactory, the nonprofit organization can use the solicitor to contact important prospects. If, on the other hand, the solicitor's performance is unsatisfactory, the nonprofit organization can terminate the solicitor's service or can assign the solicitor to other prospects or assign the prospects to other solicitors. The invention also allows the nonprofit organization to rank the solicitors based on their performance to increase the competitive spirit among the solicitors.

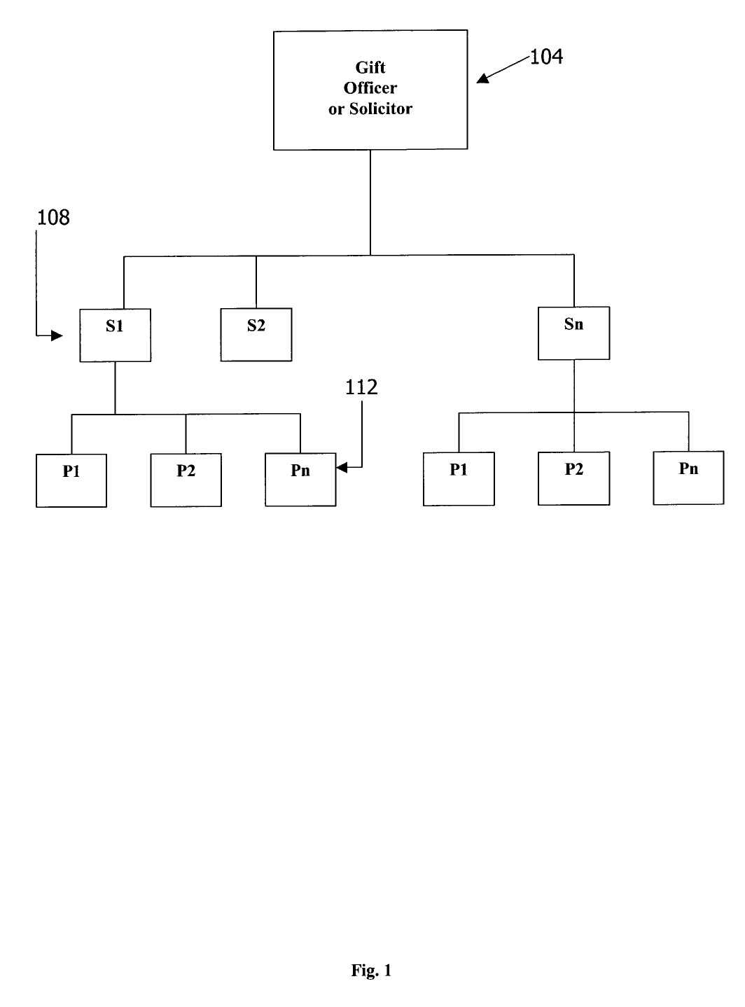

FIG. 1 illustrates a typical scenario in which the invention is utilized to supervise volunteers, employees, staff and/or other individuals (generally referred to as “solicitors”) engaged in fundraising effort and to manage the solicitors' interactions with prospects. A gift officer 104 is typically responsible for raising money for a nonprofit organization. The gift officer 104 enlists solicitors S1 . . . Sn (indicated generally by reference numeral 108) for soliciting donations. Each solicitor is responsible for contacting one or more prospects. For example, solicitor S1 is assigned to contact prospects P1, P2, . . . , Pn (indicated generally by reference numeral 112). Likewise, solicitor S2 is assigned to contact a number of prospects.

Solicitor S1 needs to establish relationship with the assigned prospects P1, P2, . . . Pn, and ultimately secure a donation from the prospects. Solicitor S1 needs to perform specific tasks such as, for example, send an email, send an email with link back to a personal web page, call a prospect, take the prospect to lunch, provide information to the prospect, take the prospect to a gala, visit the prospect's home to discuss a possible donation to the nonprofit organization. The gift officer 104 supervises the solicitor's interaction with each prospect.

In accordance with the invention, the gift officer 104 supervises the solicitors using a web-based software. The software allows the gift officer to maintain contact with the solicitors via the Internet. The software is connected to a database. In one embodiment, the database contains information about the prospects, which are provided to the solicitors. The invention includes a plurality of web pages that allow the gift officer to provide instructions to the solicitors, receive progress or status reports from the solicitors, and otherwise communicate with the solicitors.

The main features of the invention are briefly summarized below:

Web-based Software: The invention, in one embodiment, is a web-based software that allows the gift officer to manage solicitors via a wide area network such as the Internet.

Prospect Data: In one embodiment, the invention allows the nonprofit organization to empower the solicitors with prospect data prior to solicitation. The solicitors are provided with a list of prospects and relevant prospect data. The prospect data may include a prospect's prior donation history, financial situation, interests, employment, education, social groups, etc. A database includes prospect data that is connected to a web-based software. In one embodiment, the information about a particular prospect is provided to a solicitor that is assigned to the prospect. The prospect data allows the solicitors to target the prospects more effectively.

Instructions to Solicitors: The invention allows the gift officer to conveniently provide instructions to the solicitors. The solicitors can log on to the system to receive instructions that are provided in one or more web pages or emails. In one embodiment, the prospect data is used to create instructions for a particular prospect. The instructions may include a list of tasks that the solicitors need to perform in order to secure a donation from a prospect. The instruction may include a suggested amount of donation for that particular prospect based on the prospect's prior donation history, financial situation, and other criteria.

Status Updates from Solicitors: The invention allows the gift officer to receive status updates or progress reports from the solicitors. The solicitors can provide updates in a bulletin board format or by emails, or preferably into a database.

Rank Solicitors: The invention allows the nonprofit organization to rank solicitors. The solicitors can be ranked by successful task completion and/or total amount of money raised.

In one embodiment, access to the system is protected by a password. The solicitors and other officials of the nonprofit organization can logon to the system using the password. In one embodiment, the solicitor (or volunteer, employee, staff or other individual) logs on to a Head Quarter (HQ) web page.

[image]

As shown, the HQ displays fundraising statistics and includes other information such emails. The gift officer or other officials can post messages to the volunteer's inbox. In one embodiment, the HQ includes links to other web pages that provides various features of the invention. The volunteer can access the other web pages by selecting the appropriate links.

A second web page lists the prospect assigned to the volunteer (or solicitor, employee, staff or other individual).

[image]

A third web page illustrates the tasks assigned to a particular volunteer (or solicitor, employee, staff or other individual).

[image]

The solicitor needs to perform the tasks in order to secure a gift from a prospect. The solicitor responds appropriately on the web page regarding the status of the tasks. For example, the third web page shows that the solicitor is required to take a prospect to lunch. The third web page shows that the solicitor has not completed the task yet. Next, the third web page shows that the solicitor is required to call the prospect's spouse. Since the solicitor has already called the spouse, the status shows that the task has been completed. The web page can also show the date and/or time the task has been completed. If a task is not yet accomplished, the solicitor can also respond perhaps with an explanation. If the solicitor has not taken any action with respect to a task, the gift officer can send a reminder to take appropriate action or ask for an explanation. The gift officer can also add new tasks for the solicitor.

In one embodiment, the tasks include a suggested or a desired completion date. An email reminder can be sent automatically to the solicitor if a task is not completed by the completion date or if the solicitor does not provide a status update.

In one embodiment, the emails sent to the prospects from solicitors include one or more URL links to one or more web pages such as a personal web page. In one embodiment, emails are sent to the solicitors as a reminder, which can include a link back to a web page to fill in data about task completions.

In one embodiment, the invention allows the solicitors to request prospects from a list of prospects in the database. The gift officer can submit a list of prospects for the solicitors to view. The volunteers can pick from the list of prospects that they want to manage. The solicitors can view prospect data, including donation history, financial situation, interests, etc., and recommend which prospects they want assigned to them.

The invention allows the gift officer to identify the strength and weakness of each solicitor and assign prospects to the solicitors. If the solicitor is having particular success with one class of prospects (e.g., prospects within a specific age bracket), the gift officer can assign more such prospects to that solicitor. If, on the other hand, the solicitor is having difficulty with one class of prospects, the gift officer may not assign more such prospects to that solicitor. Thus, the gift officer can efficiently utilize the solicitors by assigning prospects to a solicitor in a manner that increases the likelihood of success.

In one embodiment, the total amount of money raised by each solicitor is determined. The solicitors are then ranked based on the total amount of money raised. The solicitors can also be ranked by the percentage of tasks being completed.

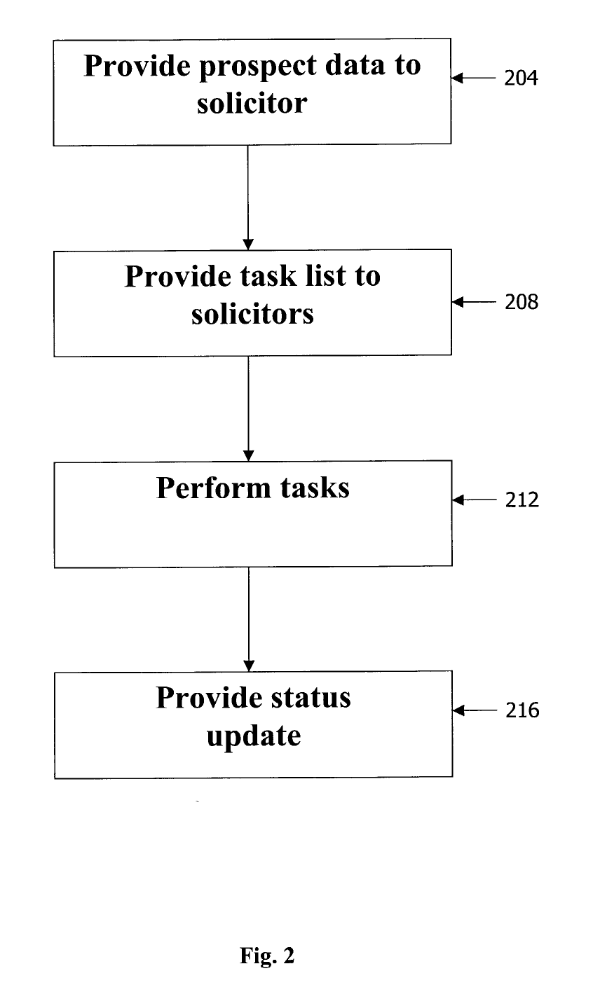

FIG. 2 is a flow diagram of the method steps in accordance with one embodiment of the invention. In step 204, a nonprofit organization (or a gift officer of the nonprofit organization) provides prospect data to a volunteer, employee, staff or other individual (generally referred to as solicitor). The prospect data is provided to the solicitor on to the HQ web page or any other web pages linked to the HQ web page. The solicitor can access the prospect data by logging on to the system using a password as described before. In step 208, the nonprofit organization provides one or more tasks to the solicitor. The tasks are provided on the HQ web page or another web page linked to the HQ web page. In step 212, the solicitor performs the task. The tasks may include contacting a prospect, providing information to the prospect, and establishing a relationship with the prospect that may lead to a donation. In one embodiment, a solicitor receives tasks for each assigned prospect. In step 216, the solicitor provides status updates regarding completed tasks and tasks yet to be completed. The solicitor may provide an explanation regarding an incomplete task or any difficulties he is facing with a prospect.

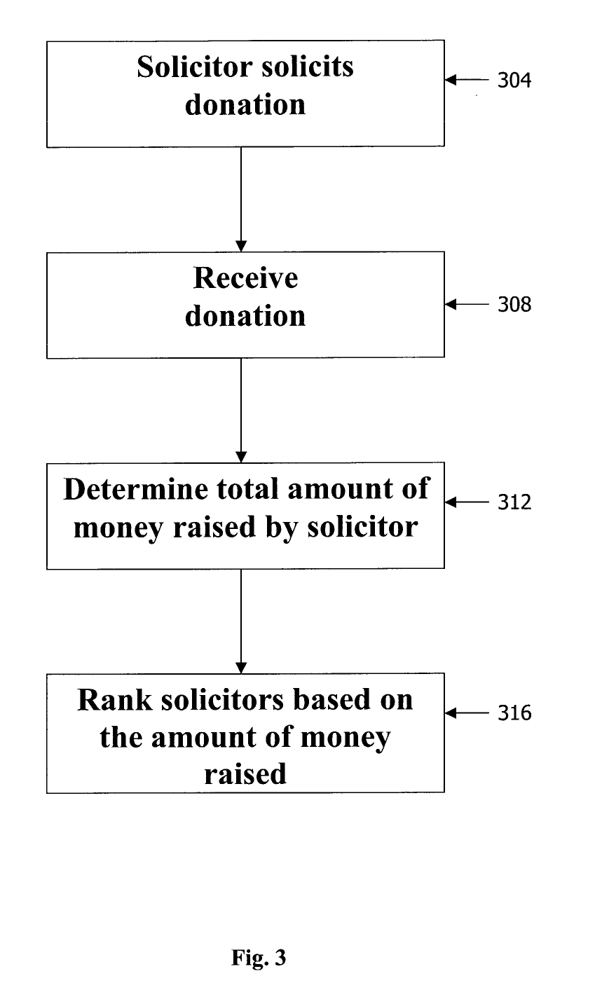

FIG. 3 is a flow diagram of additional method steps of the invention. After the solicitor establishes contact with the prospect, the solicitor, in step 304, solicits the prospect for a donation. In step 308 the prospect makes a donation (or a pledge), which is received by the nonprofit organization. The invention allows the prospect to make a pledge or a donation online or by other means, including, but not limited to, using a credit card, a debit card, electronic fund transfer, stock transfer or other assets. In step 312, the total amount of money raised by the solicitors is determined. In step 316, the solicitors are ranked based on the amount of money raised.

Thus, there has been provided, in accordance with the present invention, a distributed system and method for efficiently managing volunteers, employees, staff, solicitors or other individuals engaged in a fundraising campaign. Although the preferred embodiments have been described, it should be understood that various changes, substitutions, and alterations can be made herein without departing from the scope of the present invention. Thus the implementation of the present invention is not limited to the embodiment illustrated in this document. Other examples of changes, substitutions, and alterations are readily ascertainable by one skilled in the art and could be made without departing from the spirit and scope of the present invention as defined by the following claims.

What is claimed is:

1. A web-based distributed management system for managing and supervising a plurality of solicitors engaged in solicitation on behalf of an organization from prospects, each solicitor being assigned to solicit one or more prospects, the system including one or more web pages on the Internet, comprising:
prospect data stored in a database;
one or more tasks assigned to the solicitor, the tasks including contacting the prospects, and soliciting donations from the prospects; and
a status response including updates from the solicitor regarding the status of the tasks.

2. The system according to claim 1, wherein the prospect data includes a prospect's financial information.

3. The system according to claim 1, wherein the prospect data includes a prospect's prior donation history.

4. The system according to claim 1, wherein the status response is retained in the database.

5. The system according to claim 1, wherein the tasks are created after analyzing the prospect data.

6. The system according to claim 1, further comprising means for adding new tasks.

7. The system according to claim 1, further comprising emails for communication between the organization and the solicitors.

8. The system according to claim 1, wherein the tasks include a required completion date.

9. The system according to claim 7, further comprising means for automatically sending email reminders if the task is not completed by the required completion date.

10. The system according to claim 1, further comprising means for receiving donations from prospects.

11. The system according to claim 1, further comprising a rank of the solicitors based on the amount of money raised.

12. The system according to claim 1, further comprising a rank of the solicitors based on the number of tasks completed.

13. The system according to claim 1, further comprising means for switching prospects among solicitors.

14. The system according to claim 1, wherein the task includes a recommended amount of donation based on the prospect data.

15. A web-based method for managing and supervising a plurality of solicitors engaged in solicitation on behalf of an organization from prospects, each solicitor being assigned to solicit one or more prospects, the method utilizing one or more web pages on the Internet, comprising the steps of:
providing prospect data, retained in a database, to the solicitor;
providing one or more tasks assigned to the solicitor, the tasks including contacting the prospects, and soliciting donations from the prospects; and
providing a status response including updates from the solicitor regarding the status of the tasks.

16. The method according to claim 15, wherein the prospect data includes a prospect's financial information.

17. The method according to claim 15, wherein the prospect data includes a prospect's prior donation history.

18. The method according to claim 15, further comprising storing the status response in the database.

19. The method according to claim 15, further comprising creating the tasks after analyzing the prospect data.

20. The method according to claim 15, further comprising the step of adding new tasks.

21. The method according to claim 15, further comprising the step of soliciting a donation from the prospect.

22. The method according to claim 15, further comprising the step of receiving a donation from the prospect.

23. The method according to claim 22, further comprising the step of determining the total amount of money raised by each solicitor.

24. The method according to claim 15, further comprising the step of ranking the solicitors based on the amount of money raised.

25. The method according to claim 15, further comprising the step of ranking the solicitors based on the number of tasks completed.

26. The method according to claim 15, further including a required completion date for each task.

27. The method according to claim 26, further comprising the step of automatically sending email reminders if the task is not completed by the required completion date.

28. The method according to claim 26, further comprising the step of automatically sending an email reminder before the completion date.

29. The method according to claim 15, further comprising the step of allowing the solicitors to request prospects.

30. The method according to claim 15, further comprising the step of sending an email to the solicitors with a link back to a personal web page, wherein the solicitors can fill in data in a personal web page.

31. The system according to claim 7, further comprising means for automatically sending email reminders before the completion date.

32. The system according to claim 1, wherein the status updates are provided by emails linked to a web page where data is loaded into a database by the solicitor.

33. The system according to claim 1, wherein the status updates are provided in a bulletin board format.

34. The method according to claim 15, further comprising the step of providing status updates by emails linked to a web page where data is loaded into a database by the solicitor.

35. The method according to claim 15, further comprising the step of providing status updates in a bulletin board format.

36. A computer program product including a program code embodied in a storage medium for carrying out the method steps for managing and supervising a plurality of solicitors engaged in solicitation on behalf of an organization from prospects, each solicitor being assigned to solicit one or more prospects, the method utilizing one or more web pages on the Internet, the method comprising the steps of:
providing prospect data, retained in a database, to the solicitor;
providing one or more tasks assigned to the solicitor, the tasks including contacting the prospects, and soliciting donations from the prospects; and
providing a status response including updates from the solicitor regarding the status of the tasks.

37. The system according to claim 1, wherein the organization is a nonprofit organization.

38. The method according to claim 15, wherein the organization is a nonprofit organization.

39. The system according to claim 1, wherein the solicitor is a volunteer.

40. The method according to claim 15, wherein the solicitor is a volunteer.
